(19) United States
(12) Patent Application Publication
(10) Pub. No.: US 2013/0272785 A1
(43) Pub. Date: Oct. 17, 2013

(54) SYSTEM AND METHOD FOR COUPLING ROTOR COMPONENTS WITH A SPLINE JOINT

(71) Applicant: Edward Pan, Houston, TX (US)

(72) Inventor: Edward Pan, Houston, TX (US)

(73) Assignee: General Electric Company, Schenectady, NY (US)

(21) Appl. No.: 13/444,766

(22) Filed: Apr. 11, 2012

(51) Int. Cl. F16D 1/02

(52) U.S. Cl. 403/359.1

(57) ABSTRACT

A system includes a rotary machine. The rotary machine has a spline joint coupling first and second rotary components. The spline joint has a male spline portion and a female spline portion. The male spline portion includes a first plurality of spline teeth spaced circumferentially apart from one another about a longitudinal axis of the spline joint. The female spline portion includes a second plurality of spline teeth spaced circumferentially apart from one another about the longitudinal axis of the spline joint. The first plurality of spline teeth and the second plurality of spline teeth extend axially along the longitudinal axis. At least one tooth of the first or second plurality of spline teeth has at least one groove extending crosswise relative to the longitudinal axis. The at least one groove is disposed at an intermediate axial position between opposite axial ends of the at least one tooth.

### BACKGROUND OF THE INVENTION

The subject matter disclosed herein relates to rotary equipment and, more specifically, to a spline joint that may be employed within the rotary equipment.

Rotary equipment may employ spline joints to transfer torque between two rotating members. For example, a centrifugal pump is a type of rotary equipment that transfers energy from a rotor to a fluid via an impeller. Within the pump, a shaft may be coupled to the impeller with a spline joint. Rotation of the shaft may induce the impeller to rotate as a result. Unfortunately, spline joints may experience high contact stresses at the opposite axial ends of the spline (e.g. end zones). Further, the contact stresses may be uneven along the length of the spline joint.

### BRIEF DESCRIPTION OF THE INVENTION

Certain embodiments commensurate in scope with the originally claimed invention are summarized below. These embodiments are not intended to limit the scope of the claimed invention, but rather these embodiments are intended only to provide a brief summary of possible forms of the invention. Indeed, the invention may encompass a variety of forms that may be similar to or different from the embodiments set forth below.

In accordance with a first embodiment, a system includes a rotary machine. The rotary machine has a spline joint coupling first and second rotary components. The spline joint has a male spline portion and a female spline portion. The male spline portion includes a first plurality of spline teeth spaced circumferentially apart from one another about a longitudinal axis of the spline joint. The first plurality of spline teeth extend axially along the longitudinal axis. The female spline portion includes a second plurality of spline teeth spaced circumferentially apart from one another about the longitudinal axis of the spline joint. The second plurality of spline teeth extend axially along the longitudinal axis. At least one tooth of the first or second plurality of spline teeth has at least one groove extending crosswise relative to the longitudinal axis. The at least one groove is disposed at an intermediate axial position between opposite axial ends of the at least one tooth.

In accordance with a second embodiment, a system includes a first spline joint portion. The first spline joint portion includes a first plurality of spline teeth spaced circumferentially apart from one another about a first longitudinal axis. The first plurality of spline teeth extend axially along the first longitudinal axis. Each first tooth of the first plurality of spline teeth has a first groove extending crosswise relative to the first longitudinal axis. The first groove of each first tooth is disposed at a first intermediate axial position between opposite axial ends of the first tooth.

In accordance with a third embodiment, a system includes a solid feed pump. The solid feed pump has a first spline joint portion coupled to the solid feed pump. The first spline joint portion includes a first plurality of spline teeth spaced circumferentially apart from one another about a longitudinal axis. The first plurality of spline teeth extend axially along the longitudinal axis. A first tooth of the first plurality of spline teeth has a first groove extending crosswise relative to the longitudinal axis. The first groove of the first tooth is disposed at a first intermediate axial position between opposite axial ends of the first tooth.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is an exploded perspective view of an embodiment of a spline joint having male and female spline joint portions, each having circumferential grooves to reduce contact stress;

FIG. 2 is a partial perspective view of an embodiment of a tooth of the spline joint of FIG. 1 taken within line 2-2;

FIG. 3 is a partial perspective view of an embodiment of a tooth of the spline joint of FIG. 1 taken within line 2-2, wherein the tooth includes grooves with radial depths that alternatingly increase and decrease along the length of the tooth;

FIG. 4 is a partial perspective view of an embodiment of a tooth of the spline joint of FIG. 1 taken within the line 2-2, wherein the tooth includes grooves with radial depths that progressively change between opposite axial ends of the tooth;

FIG. 5 is a partial perspective view of an embodiment of a tooth of the spline joint of FIG. 1 taken within line 2-2, wherein the tooth includes grooves with varying axial widths;

FIG. 6 is a partial cross-sectional view of an embodiment of one of the grooves of the spline joint of FIG. 1 taken within the line 6-6 of FIGS. 2-5, wherein the groove has a rectangular shape;

FIG. 7 is a partial cross-sectional view of an embodiment of one of the grooves of the spline joint of FIG. 1 taken within the line 6-6 of FIGS. 2-5, wherein the groove has a V-shape;

FIG. 8 is a partial cross-sectional view of an embodiment one of the grooves of the spline joint of FIG. 1 taken within the line 6-6- of FIGS. 2-5, wherein the groove has a U-shape;

FIG. 9 is an exploded schematic view of an embodiment of the male and female spline joint portions of FIG. 1 prior to assembly;

FIG. 10 is a schematic view of an embodiment of the assembled spline joint of FIG. 1;

FIG. 11 is a schematic side view of an embodiment of the assembled spline joint of FIG. 10, taken along line 11-11;

FIG. 12 is a graphical representation of the axial stress profile of an embodiment of the spline joint of FIG. 1;

FIG. 13 is a block diagram of an embodiment of a turbine system that includes an embodiment of the spline joint of FIG. 1; and

FIG. 14 is a schematic cross-sectional diagram of an embodiment of a solid feed pump that includes an embodiment of the spline joint of FIG. 1.

### DETAILED DESCRIPTION OF THE INVENTION

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements.

The present disclosure is directed towards a spline joint that is designed to distribute the contact stresses relatively evenly along the length of the spline joint. In one embodiment, the spline joint includes male and female spline portions that each has spline teeth. The spline teeth of the male and female spline portions include grooves that are crosswise to a longitudinal axis. When the male spline portion is inserted into the female spline portion, each groove of the male spline portion may align with a corresponding groove of the female spline portion at a common axial position, thus forming a complete 360 degree ring about the longitudinal axis. The complete 360 degree ring decreases the contact stress at the end zones of the spline joint and distributes the contact stress more evenly along the length of the spline joint. As a result, the spline joint can be shortened while transferring the same amount of torque.

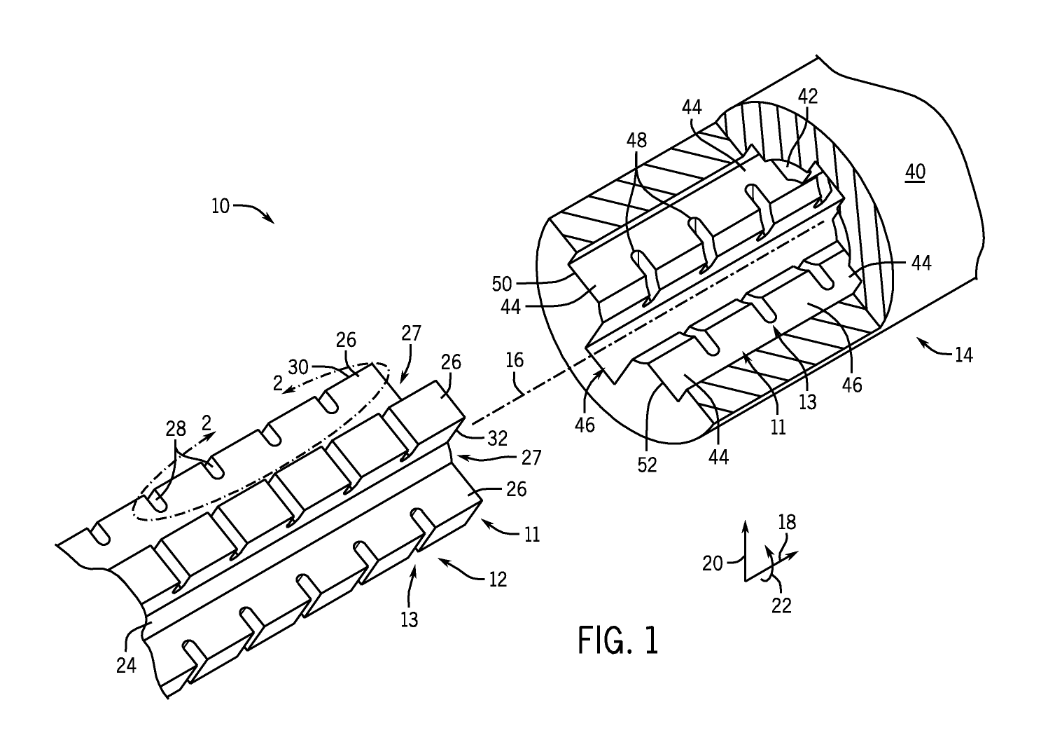

FIG. 1 is an exploded view of an embodiment of a spline joint 10 with a plurality of segmented spline teeth 11, each having one or more grooves 13 to reduce contact stresses. The spline joint 10 includes a male spline portion 12 and a female spline portion 14. As shown, the male and female spline portions 12, 14 may be coupled together along a longitudinal axis 16 (e.g., rotational axis). Throughout the discussion, a set of axes may be referenced. These axes are based on a cylindrical coordinate system and point in an axial direction 18, a radial direction 20, and a circumferential direction 22 relative to the spline joint 10. The male spline portion 12 may be inserted into the female spline portion 14 along the longitudinal axis 16 or vice versa. As a result, a rotational movement of the male spline portion 12 about the longitudinal axis 16 may induce a rotational movement of the female spline portion 14 about the longitudinal axis 16. Thus, the spline joint 10 may be used to transfer torque between two rotary components. By way of example, a pump may include the spline joint 10. The male spline portion 12 may be coupled to a pump shaft, and the female spline portion 14 may be coupled to a pump impeller or vice versa. Rotation of the pump shaft may induce a rotation in the impeller, thus imparting mechanical energy to a fluid contained within the pump. In other embodiments, the spline joint 10 may be incorporated into a rotary machine, such as a turbomachine, a generator, an engine, a transmission, a tool, or any combination thereof. For example, the spline joint 10 may be incorporated into a gas turbine engine or a solid feed pump.

As illustrated by FIG. 1, the male spline portion 12 includes a shaft 24. The shaft 24 is substantially cylindrical and extends along the longitudinal axis 16 in the axial direction 18. The male spline portion 12 includes multiple spline teeth 11, 26. As shown, the spline teeth 26 have an approximately square shape (e.g. a square spline). In other embodiments, the spline teeth 26 may have a rectangular shape, a curved shape, an involute shape, a serrated shape (V-shaped), another suitable shape, or a combination thereof. As may be appreciated, the selection of the shape of the spline teeth 26 may be implementation-specific. As illustrated, the spline teeth 26 extend radially outward from the shaft 24. Additionally, the spline teeth 26 extend axially along the shaft 24. The spline teeth 26 are circumferentially 22 spaced apart from one another about the shaft 24. As a result, spaces 27 are created circumferentially 22 between each pair of spline teeth 26. In certain embodiments, the circumferential 22 width of each space 27 may be approximately equal, such that the spline teeth 26 are spaced approximately equally about the shaft 24. As shown, the male spline portion 12 includes four spline teeth 26. In other embodiments, the number of spline teeth 26 of the male spline portion 12 may vary. For example, the male spline portion 12 may include 1, 2, 3, 4, 5, 6, 7, 8, 9, 10, or more spline teeth 26 circumferentially 22 spaced apart from one another about the shaft 24.

The spline teeth 11, 26 include grooves 13, 28 spaced axially along the spline teeth 26. As illustrated by FIG. 1, the grooves 28 extend crosswise (e.g., in the circumferential direction 22) relative to the longitudinal axis 16. In certain embodiments, the grooves 28 may be perpendicular to the longitudinal axis 16. As shown, a first spline tooth 30 of the spline teeth 26 includes a first set of grooves 28. A second spline tooth 32 of the spline teeth 26 includes a second set of grooves 28. The number of grooves 28 on each spline tooth 26 (e.g., 30, 32) may vary. Each spline tooth 26 may include 1, 2, 3, 4, 5, 6, 7, 8, 9, 10, or more grooves 28. In certain embodiments, the first spline tooth 30 may have 1 groove 28, while each remaining spline tooth 26 has 0 grooves 28. Furthermore, the location of each groove 28 on each spline tooth 26 may vary. By way of example, a spline tooth 26 may include one groove 28 that is disposed proximate to the center of the spline tooth 26. In another embodiment, a spline tooth 26 may include multiple (e.g., 2 to 100) grooves 28 spaced equally apart along the longitudinal axis 16.

As illustrated by FIG. 1, the female spline portion 14 also includes a shaft 40. The shaft includes a hollow region 42 that extends axially 18 parallel to the longitudinal axis 16. The hollow region 42 is shaped such that the male spline portion 12 may be inserted into the female spline portion 14. In certain embodiments, the male spline portion 12 may be press fit into the female spline portion 14. This may reduce the likelihood or magnitude of relative rotation (e.g., rotational slip or play) between the male or female spline portions 12, 14. As may be appreciated, relative rotation can result in additional wear of the male or female spline portions 12, 14. Certain embodiments of the spline joint 10 are designed to minimize the relative rotation of the male or female spline portions 12, 14.

The shaft 40 of the female spline portion 14 also includes spline teeth 11, 44. Similar to the spline teeth 11, 26 of the male spline portion 12, the spline teeth 44 have an approximately square shape (e.g. a square spline). However, in other embodiments, the spline teeth 44 may have a rectangular shape, a curved shape, an involute shape, a serrated shape (V-shaped), another suitable shape, or a combination thereof. As may be appreciated, the selection of the shape of the spline teeth 44 may be implementation-specific. The spline teeth 44 extend radially 20 from the shaft 40 towards the longitudinal axis 16. Additionally, the spline teeth 44 extend axially 18 along the shaft 40. The spline teeth 44 are circumferentially 22 spaced apart from one another about the longitudinal axis 16. As a result, spaces 46 are created circumferentially between each pair of spline teeth 44. In certain embodiments, the circumferential 22 width of each space 46 may be approximately equal, such that the spline teeth 44 are spaced approximately equally about the longitudinal axis 16. As shown, the female spline portion 14 includes four spline teeth 44. In other embodiments, the number of spline teeth 44 of the female spline portion 14 may vary. For example, the female spline portion 14 may include 1, 2, 3, 4, 5, or more spline teeth 44 circumferentially 22 spaced apart from one another about the shaft 40. In certain embodiments, the number of spline teeth 44 of the female spline portion 14 may be equal to the number of spaces 27 of the male spline portion 12. In particular, the spline teeth 44 of the female spline portion 14 may be designed to fit into the spaces 27 between the spline teeth 26 of the male spline portion 12.

The spline teeth 11, 44 also include grooves 13, 48 spaced axially 18 along the spline teeth 44. As illustrated by FIG. 1, the grooves 48 extend crosswise (e.g., in the circumferential direction 22) relative to the longitudinal axis 16. In certain embodiments, the grooves 48 may be perpendicular to the longitudinal axis 16. As shown, a first spline tooth 50 of the spline teeth 44 includes a first set of grooves 48. A second spline tooth 52 of the spline teeth 44 includes a second set of grooves 48. The number of grooves 48 on each spline tooth 44 (e.g., 50, 52) may vary. Each spline tooth 44 may include 1, 2, 3, 4, 5, 6, 7, 8, 9, 10, or more grooves 48. In certain embodiments, the first spline tooth 50 may have 1 groove 48, while each remaining spline tooth 44 has 0 grooves 48. Furthermore, the location of each groove 48 on each spline tooth 44 may vary. By way of example, a spline tooth 44 may include one groove 48 that is disposed proximate to the center of the spline 44. In another embodiment, a spline tooth 44 may include multiple (e.g., 2 to 100) grooves 48 spaced equally apart along the longitudinal axis 16.

As noted above, the spline teeth 11, 44 may be designed to fit in the spaces 27 between the teeth 26 of the male spline portion 12. In additional, the spline teeth 11, 26 of the male spline portion 12 may be designed to fit in the spaces 46 between the spline teeth 44 of the female spline portion 14. In certain embodiments, each spline tooth 26, 44 includes the same number of grooves 13, 28, 48 disposed at approximately the same axial 18 positions along each tooth 26, 44. Thus, when the male spline portion 12 is inserted into the female spline portion 14, each groove 26 may align with the corresponding groove 44 at a common axial 18 position to form a continuous and complete 360 degree ring about the longitudinal axis 16, as will be described further in FIGS. 10 and 11. The ring of grooves 26, 44 decreases the contact stress at the end zones of the spline joint 10. Further, the ring of grooves 26, 44 more evenly distributes the contact stress along the length of the spline joint 10.

As illustrated, the spline teeth 11, 26 of the male spline portion 12 include the grooves 13, 28, and the spline teeth 44 of the female spline portion 14 include the grooves 48. In other embodiments, the spline teeth 44 of the female spline portion 14 may not include the grooves 48. Instead, only the spline teeth 26 of the male spline portion 12 may include the grooves 28. In yet other embodiments, the opposite case is true: the spline teeth 26 of the male spline portion 12 may not include the grooves 28. Instead, only the spline teeth 44 of the female spline portion 14 may include the grooves 48. As may be appreciated, the distribution of the grooves 28, 48 among the spline teeth 26, 44 may be implementation-specific and may vary among embodiments. In general, a spline joint 10 may have any arrangement of grooves 13 on one or more spline teeth of the male and/or female spline portions 12, 14.

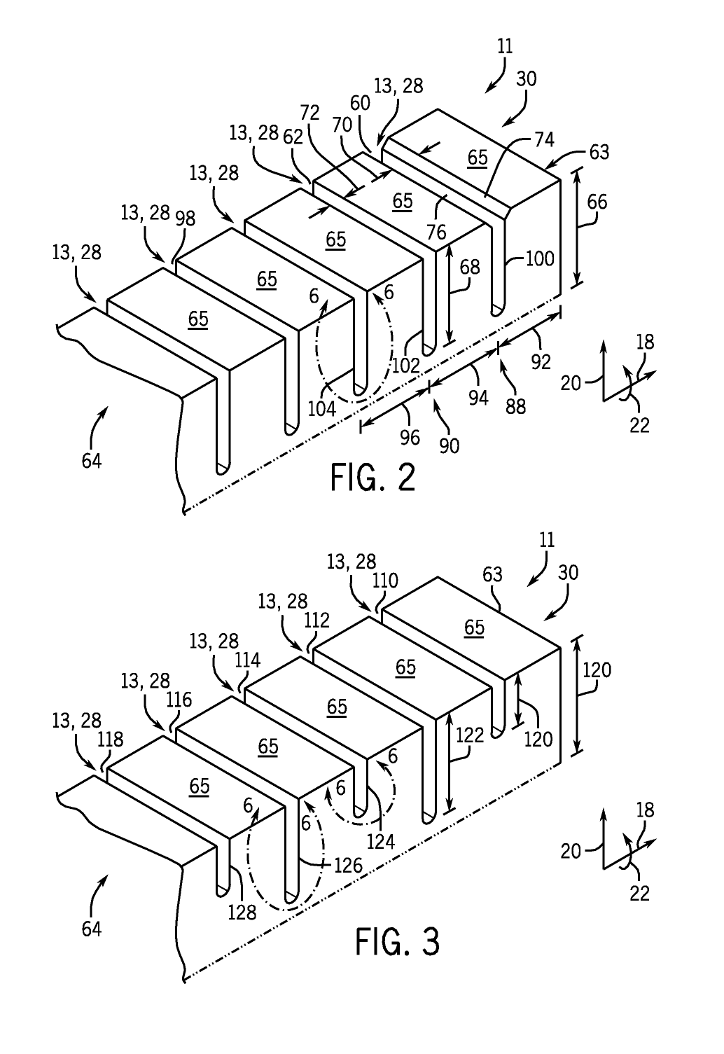

As discussed above, the spline teeth 11, 26, 44 of the male and female spline portions 12, 14 may include grooves 13, 28, 48. FIG. 2 is a perspective view of an embodiment of the first spline tooth 30 of the male spline portion 12 that includes a plurality of grooves 28. However, as may be appreciated, FIG. 2 is also a representative view of an embodiment of the first spline tooth 50 of the female spline portion 14 illustrating the grooves 48. Each tooth 26, 44 (e.g., 30) may have any number of grooves, such as a single groove or multiple grooves (e.g., 2 to 100). Without loss of generality, the male spline portion 12 includes multiple grooves 28, such as a first groove 60 and a second groove 62, which may be the same or different from one another. As may be appreciated, an embodiment of the first spline tooth 30 may only include a single groove 28 and thus may only include the first groove 60. The grooves 28 (e.g., 60, 62) may be disposed at a variety of axial 18 positions between opposite first and second axial ends 63, 64. As discussed previously, the grooves 28 extend crosswise relative to the longitudinal axis 16. The grooves 28 axially divide the spline tooth 30 into spline tooth portions 65. In addition, the spline tooth portions 65 may have equal or variable spacing. In certain embodiments, the contact stress of the spline coupling joint 10 may be more evenly distributed among the spline tooth portions 65.

The first groove 13, 60 extends a radial depth 66 into the first spline tooth 11, 30. Similarly, the second groove 13, 62 extends a radial depth 68 into the first spline tooth 11, 30. As illustrated, the radial depths 66, 68 of the first and second grooves 60, 62 are uniform. In other embodiments, as will be described further in FIG. 3, the radial depths 66, 68 of the first and second grooves 60, 62 may vary. The first groove 60 has an axial width 70. Similarly, the second groove 62 has an axial width 72. As illustrated, the axial widths 70, 72 are uniform. In other embodiments, as will be described further in FIG. 5, the axial widths 70, 72 of the first and second grooves 70, 72 may vary. As may be appreciated, the axial width 70 of the first groove 60 may vary along the radial depth 66. For example, the first groove 60 includes chamfered edges 74, 76. The chamfered edges 74, 76 may decrease the contact stress of the spline joint 10 at the first groove 60. In certain embodiments, the first groove 60 may not include the chamfered edges 74, 76 and may be substantially similar to the second groove 62. In other embodiments, the chamfered edges 74, 76 of the first groove 60 may instead be rounded. Further, all of the grooves 28 (e.g., 60, 62) may include or exclude the chamfered edges 74, 76. Similarly, all of the grooves 28 may have equal or different radial depths and/or axial widths.

In certain embodiments, the axial positions and axial spacings (e.g., spline tooth portions 65) between the grooves 28 (e.g., 60, 62, 98) and the ends 63, 64 may be equal or different from one another. As illustrated, the first groove 60 is disposed at a first axial position 88. Similarly, the second groove 62 is disposed at a second axial position 90. More specifically, the first and second axial positions 88, 90 are intermediate between the opposite axial ends 63, 64 of the spline tooth 30. Further, the first and second axial positions 88, 90 are offset from one another. The first groove 60 has an axial spacing 92 from the axial end 63 and an axial spacing 94 from the second groove 62. Similarly, the second groove 62 also has the axial spacing 94 from the first groove and an axial spacing 96 from a third groove 98. In certain embodiments, the axial spacings 92, 94 may be approximately equal, such that the first groove 60 is equally spaced between the axial end 63 and the second groove 63. Similarly, the axial spacings 94, 96 may be approximately equal, such that the second groove 62 is equally spaced between the first groove 60 and the third groove 98. In certain embodiments, the first spline tooth 30 may include only the first and second grooves 60, 62 disposed between opposite axial 63, 64 ends of the first spline tooth 30. In such an embodiment, the first groove 60 may be equally spaced between the axial end 63 and the second groove 62, and the second groove 62 may be equally spaced between the first groove 60 and the second axial end 64. Thus, in certain embodiments with multiple (e.g., 2-100) grooves 28, the grooves 28 may be equally spaced between the opposite axial ends 63, 64.

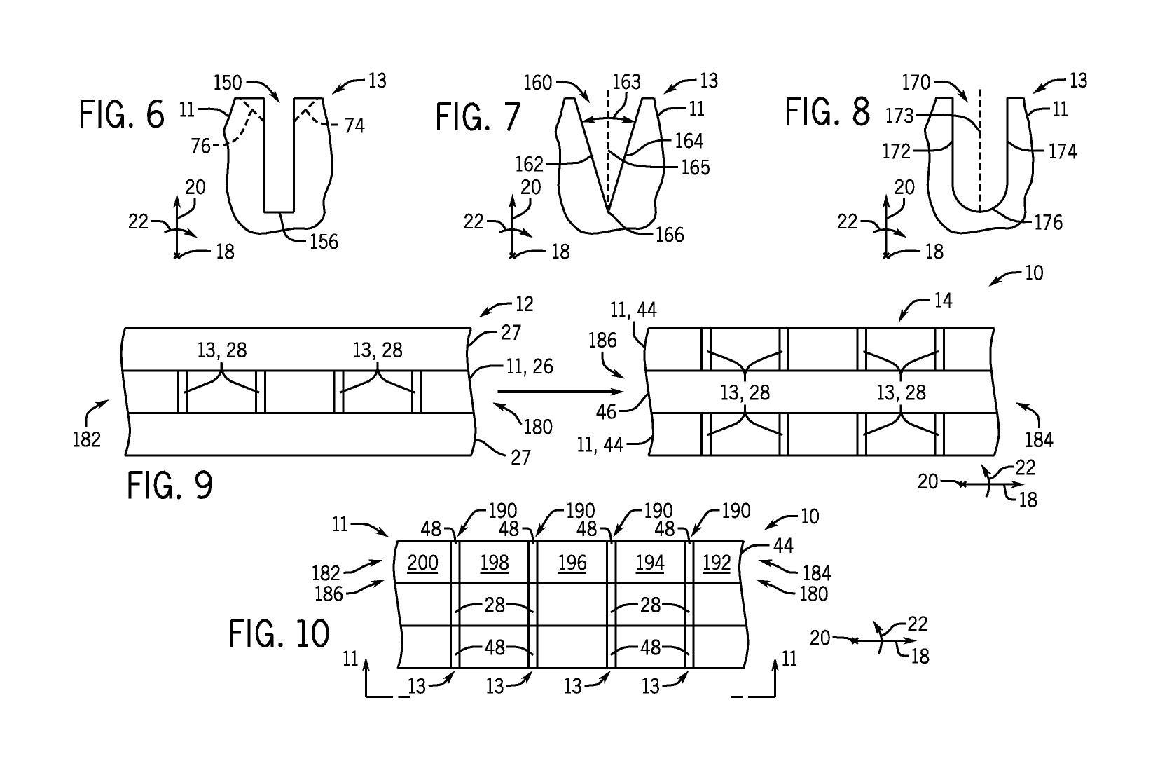

The grooves 13, 28 (e.g., first groove 60) has a cross-sectional shape 100, as will be described further in FIGS. 6-8. Similarly, the second and third grooves 62, 98 have cross-sectional shapes 102, 104. As illustrated by FIG. 2, the first and second grooves have uniform radial depths 66, 68; uniform axial widths 70, 72; uniform axial spacings 92, 94, 96; and uniform shapes 100, 102. In other embodiments, as best illustrated by FIGS. 3-5, the aforementioned characteristics or a combination thereof may vary.

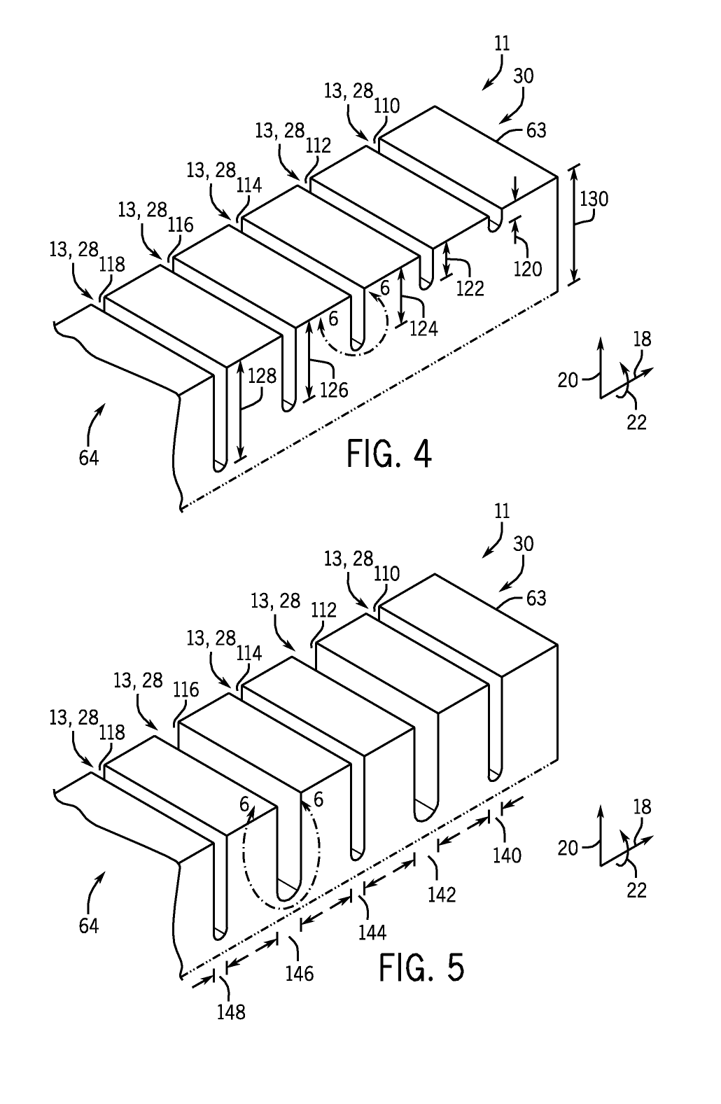

FIG. 3 illustrates an embodiment of the first spline tooth 30 of the male spline portion 12 including grooves 13, 28 that vary in radial 20 depth. However, as may be appreciated, FIG. 3 also illustrates a representative view of an embodiment of the first spline tooth 50 of the female spline portion 14 including the grooves 48. As shown, the first spline tooth 30 includes five grooves 110, 112, 114, 116, 118 that each has a radial depth 120, 122, 124, 126, 128. The radial depths 122, 126 of the grooves 112, 116 extend radially through the entire spline tooth 30. In other words, the radial depths 122, 126 are approximately equal to a radial height 130 of the first spline tooth 30. On the other hand, the radial depths 120, 124, 128 of the grooves 110, 114, 118 extend radially 20 through a portion of the first spline tooth 30. In other words, the radial depths 120, 124, 128 are less than (e.g., approximately 1 to 99 percent of) the radial height 130 of the first spline tooth 30. For example, the radial depths 120, 124, 128 may be approximately 10 to 90, 20 to 80, 30 to 70, 40 to 60, or about 50 percent of the radial height 130 and/or the radial depths 122, 126. As illustrated, the radial depths 120, 122, 124, 126, 128 alternatingly increase and decrease in the series of adjacent grooves 110, 112, 114, 116, 118. In other embodiments, as may be illustrated by FIG. 4, the radial depths 110, 112, 114, 116, 118 may progressively change between the opposite axial ends 63, 64 of the first spline tooth 30.

FIG. 4 illustrates an embodiment of the spline tooth 11 (e.g., first spline tooth 30) of the male spline portion 12 that includes grooves 110, 112, 114, 116, 118 that have radial depths 120, 122, 124, 126, 128. As discussed previously, FIG. 4 is also a representative view of an embodiment of the first spline tooth 50 of the female spline portion 14. As illustrated, the radial depths 120, 122, 124, 126, 128 gradually and progressively increase from the axial end 63 to the opposite axial end 64. In other embodiments, the radial depths 120, 122, 124, 126, 128 may gradually and progressively decrease from the axial end 63 to the opposite axial end 64. As may be appreciated, the radial depths, axial widths, axial spacings, shapes of the grooves 110, 112, 114, 116, 118, or a combination thereof, may vary from the axial end 63 to the opposite axial end 64. For example, the radial depths 120, 122, 124, 126, 128 may be approximately 20, 40, 60, 80, or 100 percent of the radial height 130. Furthermore, these characteristics may progressively and/or gradually change from the axial end 63 to the opposite axial end 64 of the first spline tooth 30. For example, the radial depths 120, 122, 124, 126, 128 may gradually increase by approximately 5, 10, 15, 20, 25, 30, 35, 40, 45, or 50 percent increments.

FIG. 5 illustrates an embodiment of the spline tooth 11 (e.g., first spline tooth 30) of the male spline portion 12 including grooves 13, 28 that vary in axial 18 width. However, as may be appreciated, FIG. 5 also illustrates a representative view of an embodiment of the first spline tooth 50 of the female spline portion 14 including the grooves 48. As shown, the first spline tooth 30 includes the grooves 110, 112, 114, 116, 118 that each has an axial width 140, 142, 144, 146, 148. In the illustrated embodiment, the axial widths 142, 146 are wider than the axial widths 140, 144, 148. In particular, the axial widths 140, 142, 144, 146, 148 alternatingly increase and decrease in the series of adjacent grooves 110, 112, 114, 116, 118. In other embodiments, the axial widths 140, 142, 144, 146, and 148 may progressively and/or gradually change from the axial end 63 to the opposite axial end 64.

As discussed previously, the grooves 13 (e.g., first and second grooves 60, 62) of the first spline tooth 30 have cross-sectional shapes 100, 102. FIGS. 6-8 illustrate different cross-sectional shapes 100 of certain embodiments of the grooves 13, e.g., the first groove 60. As shown in FIG. 6, one or more grooves 13 of the teeth 11 may include a rectangular shape 150. The rectangular shape 150 includes two generally parallel sides 152, 154 extending lengthwise along the longitudinal axis 16. The sides 152, 154 are generally defined by planes extending along the axial and radial directions 18, 20. In addition, the rectangular shape 150 includes a base 156 that is perpendicular to the sides 152, 154 and parallel to the longitudinal axis 16. In some embodiments, the sides 152, 154 may be shaped to include the chamfered edges 74, 76. As shown in FIG. 7, one or more grooves 13 of the teeth 11 may include a triangular, converging, or V-shape 160. The V-shape 160 includes two sides 162, 164 that are crosswise (e.g., converging) relative to each other, such that the sides 162, 164 are angled 163 inwardly toward a common point 166. For example, the angle 163 may be approximately, 10 to 170, 30 to 140, 70 to 110, or 80 to 100 degrees. As illustrated, the sides 162, 164 are substantially planar and are symmetrical about a radial line 165 leading to the common point 166. In other embodiments, the sides 162, 164 may be arcuate or include arcuate portions. Further, in other embodiments, the sides 162, 164 may not be symmetrical about the radial line 165 leading to the common point 166. Finally, as shown in FIG. 8, one or more grooves 13 of the teeth 11 may include a curved or a U-shape 170. The U-shape 170 includes two sides 172, 174 and an arcuate base 176. The sides 172, 174 are symmetrical about the base 176 and a radial line 173. As may be appreciated, each groove 13 (e.g., 28, 60, 62, 98, 48) of each tooth 11 (e.g., 26, 30, 32, 44, 50, 52) may include the rectangular shape 150, the V-shape 160, or the U-shape 170, or any other groove shape. Furthermore, each tooth 11 may have any combination of equal or different groove 13 shapes, such as the rectangular shape 150, the V-shape 160, or the U-shape 170, or any other shape. Further, the cross-sectional shapes 150, 160, 170 are provided by way of example only, and are not intended to be limiting. For example, in other embodiments, the cross-sectional shapes of the grooves 13 may be polygonal, elliptical, or otherwise arcuate, among other variations.

As previously discussed, the male and female spline portions 12, 14 include the spline teeth 11, 26, 44 with the grooves 13, 28, 48. In addition, the male spline portion 12 may be inserted into the female spline portion 14 along the longitudinal axis 16. FIG. 9 illustrates the insertion of the male spline portion 12 into the female spline portion 14. In particular, the male spline portion 12 extends from a first axial end 180 to an opposite axial end 182. Similarly, the female spline portion 14 extends from a first axial end 184 to an opposite axial end 186. The first axial end 180 of the male spline portion 12 is inserted into the hollow region 42 (FIG. 1) disposed at the opposite axial end 186 of the female spline portion 14. Specifically, the spline teeth 26 are inserted into the spaces 46 between the spline teeth 44. Similarly, the spline teeth 44 are inserted into with the spaces 27 between the spline teeth 26.

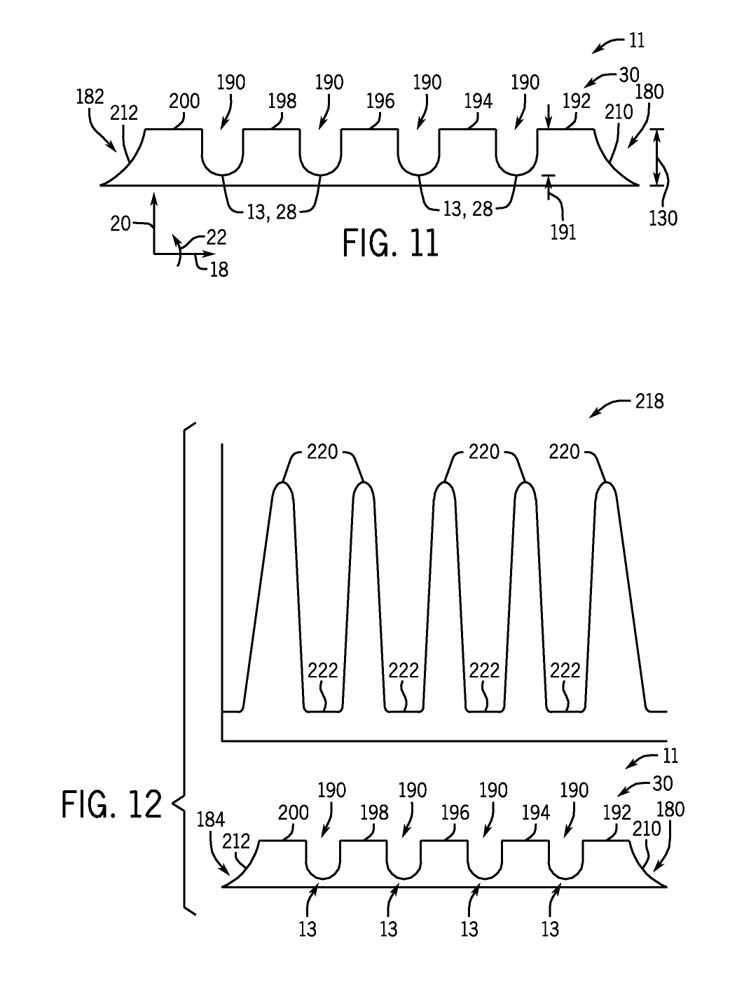

FIG. 10 illustrates the spline joint 10 after the male spline portion 12 is inserted into the female spline portion 14. As shown, the axial ends 182, 186 of the male and female spline portions 12, 14 are axially 18 aligned with each other, and the axial ends 180, 184 of the male and female spline portions 12, 14 are axially 18 aligned with each other. Additionally, the grooves 13, 28 of the male spline portion 12 and the grooves 48 of the female spline portion 14 are aligned at common axial positions. Further, the aligned grooves 28, 48 form continuous 360 degree rings 190 that extend circumferentially 22 about the longitudinal axis 16. The continuous rings 190 may axially subdivide the spline joint 10 into axial portions 192, 194, 196, 198, 200. The contact stress of the spline joint 10 is distributed more evenly among the axial portions 192, 194, 196, 198, 200, resulting in greater operability of the spline joint portion 10. This redistribution of stress is discussed further below in FIG. 12.

FIG. 11 is a schematic side view of the spline joint 10 after the male spline portion 12 has been inserted into the female spline portion 14, as indicated by line 11-11 of FIG. 10. The spline tooth shown is the spline tooth 11 (e.g., first spline tooth 30) of the male spline portion 12. As may be appreciated, FIG. 11 is also representative of the first spline tooth 50 of the female spline portion 14. As illustrated, the continuous rings 190 axially divide the spline joint into the axial portions 192, 194, 196, 198, 200. Further, a radial depth 191 of the continuous rings 190 (e.g., grooves 13, 28) is less than the radial height 130 of the first spline tooth 30. In other embodiments, the radial depth 191 of the continuous rings 190 (e.g., grooves 13, 28) may extend through the entire radial height 130 of the first spline tooth 30. As shown, the first spline tooth 30 includes two arcuate portions 210, 212 disposed at the axial ends 180, 182 of the male spline portion 12. The arcuate portions 210, 212 may decrease the contact stress of the spline joint at the axial ends 180, 182, as illustrated further in FIG. 12.

FIG. 12 graphically illustrates an axial stress profile 218 of an embodiment the spline joint 10. As shown, the axial stress profile 218 has peaks 220 of higher contact stress and troughs 222 of lower contact stress. The peaks 220 generally correspond to the axial positions of the continuous rings 190 and the arcuate portions 210, 212 of the first spline tooth 30. On the other hand, the troughs 222 generally correspond to the axial portions 192, 194, 196, 198, 200 of the spline joint 10. As may be appreciated, the peaks 220 are lower compared to a spline joint that does not include the continuous rings 190 (e.g., grooves 13). In addition, the lower peaks 220 may enable the spline joint 10 to be shorter compared to a spline joint that does not include the continuous rings 190 (e.g., grooves 13). Further, the rings 190 (e.g., grooves 13) help to more evenly distribute stress, so that each peak is much lower. Thus, it may be desirable to employ the spline joint 10 within systems that include rotary components used to transfer torque, such as a turbomachine (e.g., gas turbine engine or solid feed pump).

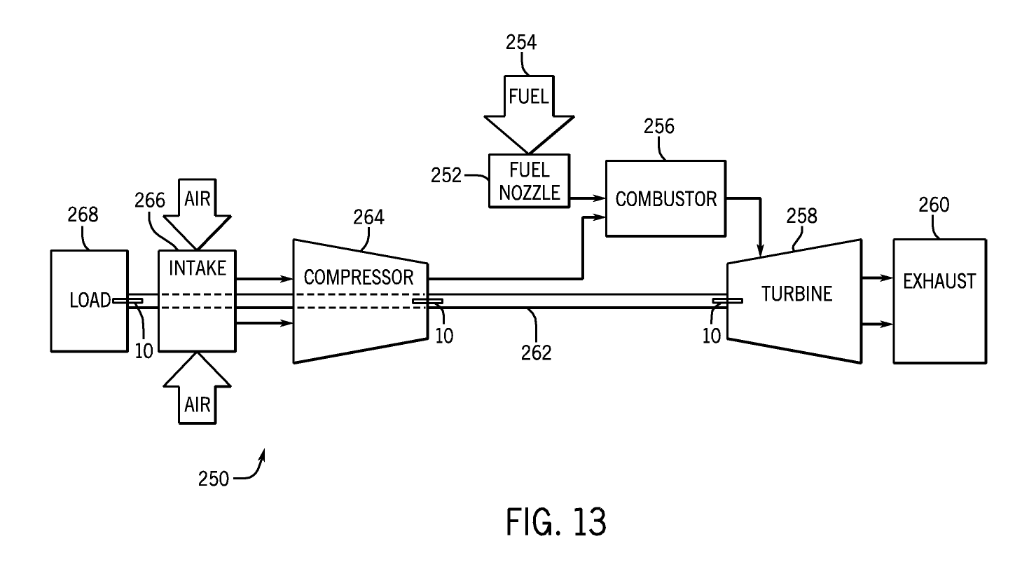

FIG. 13 is a block diagram of an embodiment of a turbine system 250 that includes the spline joint 10 with one or more segmented teeth 11 with grooves 13. The gas turbine engine 250 may employ one or more fuel nozzles 252. The turbine system 250 may use liquid or gas fuel, such as natural gas and/or a hydrogen rich synthetic gas, to drive the turbine system 250. As depicted, one or more fuel nozzles 252 intake a fuel supply 254, mix the fuel with air, and distribute the air-fuel mixture into a combustor 256 in a suitable ratio for optimal combustion, emissions, fuel consumption, and power output. The air-fuel mixture combusts in a chamber within the combustor 256, thereby creating hot pressurized exhaust gases. The combustor 256 directs the exhaust gases through a turbine 258 toward an exhaust outlet 260. As the exhaust gases pass through the turbine 18, the gases force turbine blades to rotate a shaft 262 along an axis of the turbine system 250. As illustrated, the shaft 262 may be connected to various components of the turbine system 250, including a compressor 264. The compressor 264 also includes blades coupled to the shaft 262. As the shaft 262 rotates, the blades within the compressor 264 also rotate, thereby compressing air from an air intake 266 through the compressor 264 and into the fuel nozzles 252 and/or combustor 256. The shaft 262 may also be connected to a load 268, which may be a vehicle or a stationary load, such as an electrical generator in a power plant or a propeller on an aircraft, for example. The load 268 may include any suitable device capable of being powered by the rotational output of the turbine system 250.

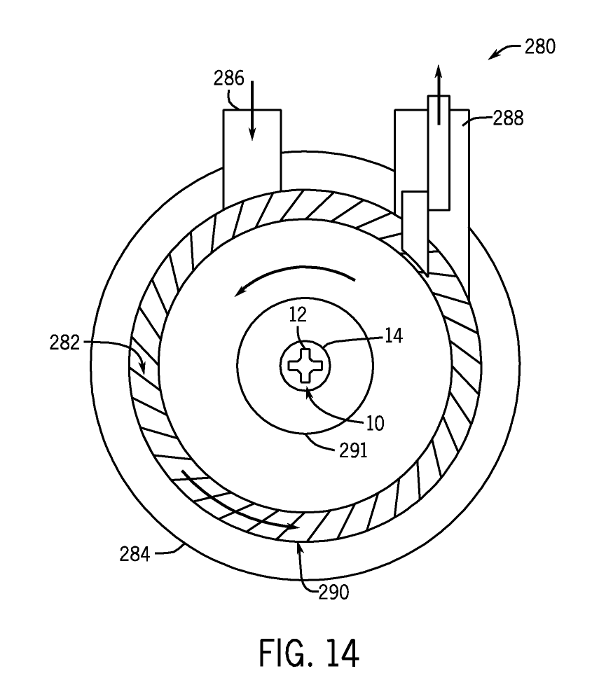

FIG. 14 is a schematic diagram of an embodiment of a solid feed pump 280 that includes the spline joint 10. The solid feed pump 280 may be Posimetric® pump made by General Electric Company of Schenectady, New York. The term “posimetric” may be defined as capable of metering and positively displacing a substance within a passage 282 of the pump 280. As shown in FIG. 1, the illustrated solid feed pump 280 includes a housing 284, inlet 286, outlet 288, and rotor 290. The rotor 290 includes the spline joint 10, and may be connected to a shaft and/or hub 291. As the shaft 291 rotates, the spline joint 10 induces the rotor 290 to rotate. This rotation may induce a flow through the pump 280 and enable the pump 280 to transport a solid feedstock (e.g., a solid fuel feedstock). In certain embodiments, the pump 280 may include the male spline portion 12 or the female spline portion 14, or both. The pump 280 may be used to pump a solid fuel feedstock to a variety of reactors, combustors, or gasifiers. For example, the pump 280 may be part of a gasification system that includes a gasifier, which receive the solid fuel feedstock from the pump 280.

Technical effects of the disclosed embodiments include a spline joint that is designed to distribute the contact stresses relatively evenly along the length of the spline joint. In one embodiment, the spline teeth of the male and female spline portions include grooves that are crosswise to a longitudinal axis. When the male spline portion is inserted into the female spline portion, each groove of the male spline portion may align with a corresponding groove of the female spline portion at a common axial position, thus forming a complete 360 degree ring about the longitudinal axis. The complete 360 degree ring decreases the contact stress at the end zones of the spline joint and distributes the contact stress relatively evenly along the length of the spline joint. As a result, the spline joint can be shortened while transferring the same amount of torque.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A system, comprising:
a rotary machine, comprising:
a spline joint coupling first and second rotary components; wherein the spline joint comprises:
a male spline portion comprising a first plurality of spline teeth spaced circumferentially apart from one another about a longitudinal axis of the spline joint, wherein the first plurality of spline teeth extend axially along the longitudinal axis; and
a female spline portion comprising a second plurality of spline teeth spaced circumferentially apart from one another about the longitudinal axis of the spline joint, wherein the second plurality of spline teeth extend axially along the longitudinal axis;
wherein at least one tooth of the first or second plurality of spline teeth comprises at least one groove extending crosswise relative to the longitudinal axis, and the at least one groove is disposed at an intermediate axial position between opposite axial ends of the at least one tooth.

2. The system of claim 1, wherein the at least one tooth is one of the first plurality of spline teeth on the male spline portion.

3. The system of claim 1, wherein the at least one tooth is one of the second plurality of spline teeth on the female spline portion.

4. The system of claim 1, wherein each first tooth of the first plurality of spline teeth comprises a first groove extending crosswise relative to the longitudinal axis, and each second tooth of the second plurality of spline teeth comprises a second groove extending crosswise relative to the longitudinal axis.

5. The system of claim 4, wherein the first and second grooves are disposed at a common axial position while the male and female spline portions are coupled to one another.

6. The system of claim 1, wherein the at least one groove comprises a rectangular groove, a V-shaped groove, or a U-shaped groove.

7. The system of claim 1, wherein the at least one groove comprises a first groove and a second groove each extending crosswise relative to the longitudinal axis, the first groove is disposed at a first intermediate axial position between the opposite axial ends of the at least one tooth, the second groove is disposed at a second intermediate axial position between the opposite axial ends of the at least one tooth, and the first and second grooves are axially offset from one another.

8. The system of claim 7, wherein the first groove is equally spaced between a first axial end of the at least one tooth and the second groove, and the second groove is equally spaced between a second axial end of the at least one tooth and the first groove.

9. The system of claim 7, wherein the first and second grooves have uniform radial depths and uniform axial widths.

10. The system of claim 7, wherein the first and second grooves have different radial depths or different axial widths.

11. The system of claim 1, wherein the at least one groove comprises a plurality of grooves extending crosswise relative to the longitudinal axis, and the plurality of grooves progressively change in at least one characteristic between the opposite axial ends of the at least one tooth.

12. The system of claim 11, wherein the at least one characteristic comprises a radial depth, an axial width, an axial spacing, a shape, or a combination thereof.

13. The system of claim 1, wherein the rotary machine comprises a turbomachine.

14. The system of claim 1, wherein the rotary machine comprises a solid feed pump.

15. A system, comprising:
a first spline joint portion comprising a first plurality of spline teeth spaced circumferentially apart from one another about a first longitudinal axis, wherein the first plurality of spline teeth extend axially along the first longitudinal axis, each first tooth of the first plurality of spline teeth comprises a first groove extending crosswise relative to the first longitudinal axis, and the first groove of each first tooth is disposed at a first intermediate axial position between opposite axial ends of the first tooth.

16. The system of claim 15, comprising a second spline joint portion configured to mate with the first spline joint portion, wherein the second spline joint portion comprises a second plurality of spline teeth spaced circumferentially apart from one another about a second longitudinal axis, the second plurality of spline teeth extend axially along the second longitudinal axis, each second tooth of the second plurality of spline teeth comprises a second groove extending crosswise relative to the second longitudinal axis, and the second groove of each second tooth is disposed at a second intermediate axial position between opposite axial ends of the second tooth.

17. The system of claim 15, comprising a turbomachine having the first spline joint portion.

18. The system of claim 15, comprising a solid feed pump having the first spline joint portion.

19. A system, comprising:
a solid feed pump; and
a first spline joint portion coupled to the solid feed pump, wherein the first spline joint portion comprises a first plurality of spline teeth spaced circumferentially apart from one another about a longitudinal axis, the first plurality of spline teeth extend axially along the longitudinal axis, a first tooth of the first plurality of spline teeth comprises a first groove extending crosswise relative to the longitudinal axis, and the first groove of the first tooth is disposed at a first intermediate axial position between opposite axial ends of the first tooth.

20. The system of claim 19, wherein the first groove is configured to divide the first tooth into a plurality of spline sections, and the first groove is configured to reduce contact stress at the opposite axial ends of the first tooth by distributing the contact stress among the plurality of spline sections.
